(19) United States
(12) Patent Application Publication
(10) Pub. No.: US 2001/0040621 A1
(43) Pub. Date: Nov. 15, 2001

(54) VIDEOPHONE ADVERTISEMENT WHEN CALLING VIDEO NON-ENABLED VIDEOPHONE USERS

(76) Inventors: IRWIN GERSZBERG, KENDALL PARK, NJ (US); JEFFREY S. MARTIN, DOVER, NJ (US); HOPETON S. WALKER, HALEDON, NJ (US)

Correspondence Address: S H DWORETSKY, GENERAL ATTORNEY, AT&T CORP., PO BOX 4110, MIDDLETOWN, NJ, 07748

(21) Appl. No.: 09/001,361

(22) Filed: Dec. 31, 1997

(51) Int. Cl. H04N 7/14; H04M 11/00

(52) U.S. Cl. 348/14.01; 348/14.03; 379/93.12; 379/93.19

(57) ABSTRACT

An advertisement system for displaying advertisements on a video-enabled telephone when the telephone is linked with a non-video enabled telephone and/or when the videophone is put on hold.

### FIELD OF THE INVENTION

The present invention is directed to video telephones, and more specifically to video advertising on video telephones.

### BACKGROUND

As deregulation of the telephone industry continues and as companies prepare to enter the local telephone access market, there is a need to offer new and innovative services that distinguish common carriers from their competitors. This cannot be accomplished without introducing new local access network architectures that will be able to support these new and innovative services.

Conventionally, customer premises telephone and/or data connections contain splitters for separating analog voice calls from other data services such as Ethernet transported over digital subscriber line (DSL) modems. Voice band data and voice signals are sent through a communications switch in a central or local office to an interexchange carrier or Internet service provider. DSL data is sent through a digital subscriber loop asynchronous mode (DSLAM) switch which may include a router. The DSLAM switch connects many lines and routes the digital data to a telephone company's digital switch.

A major problem with this configuration is that interexchange carriers attempting to penetrate the local telephone company's territory must lease trunk lines from the local telephone company switch to the interexchange company's network for digital traffic. Furthermore, the Internet service provider must lease a modem from the local phone company in the DSLAM switch and route its data through the local phone company's digital switch. Thus, the local phone company leases and/or provides a significant amount of equipment, driving up the cost of entry for any other company trying to provide local telephone services and making it difficult for the interexchange companies to differentiate their services. Furthermore, since DSL modem technology is not standardized, in order to ensure compatibility, the DSL modem provided by the local telephone company must also be provided to the end user in the customer premises equipment (CPE). Additionally, since the network is not completely controlled by the interexchange companies, it is difficult for the interexchange companies to provide data at committed delivery rates. Any performance improvements implemented by the interexchange companies may not be realized by their customers, because the capabilities of the local telephone company equipment may or may not meet their performance needs. Thus, it is difficult for the interexchange companies to convince potential customers to switch to their equipment or to use their services. These factors ensure the continued market presence of the local telephone company.

As part of this system, there is a need for improved architectures, services and equipment utilized to distinguish the interexchange companies' products and services.

Furthermore, long-distance telephone calls are usually expensive. One reason for this is that the costs for maintaining and operating a telephone and/or data network are tyically ultimately paid for by the customer. As these networks become more sophisticated and offer more features, and as more customers use improved technology such as videophones, these costs for network operation and maintenance, and thus the costs to the customer, may rise. There is therefore a growing need for new and creative ways for reducing costs to telephone network customers.

### SUMMARY OF THE INVENTION

In order to provide an improved network, it is desirable for the interexchange companies to have access to at least one of the twisted-pair lines or alternate wireless facility connecting each of the individual users to the local telephone network before the lines are routed through the conventional local telephone network equipment. It is preferable to have access to these lines prior to the splitter and modem technology offered by the local service providers. By having access to the twisted-pair wires entering the customer's premises, interexchange companies can differentiate their services by providing higher bandwidth, improving the capabilities of the customer premises equipment, and lowering overall system costs to the customer by providing competitive service alternatives.

The new architecture may utilize a video phone and/or other devices to provide new services to an end user; an intelligent services director (ISD) disposed near the customer's premises for multiplexing and coordinating many digital services onto a single twisted-pair line; a facilities management platform (FMP) disposed in the local telephone network's central office for routing data to an appropriate interexchange company network; and a network server platform (NSP) coupled to the FMP for providing new and innovative services to the customer and for distinguishing services provided by the interexchange companies from those services provided by the local telephone network.

As part of this system, one aspect of the present invention provides systems and methods for displaying video advertisements on a videophone when the videophone is linked to a non-video-enabled telephone. Since some or all of the videophone's display might not be otherwise used, and the videophone user may be near the videophone during a telephone call, the user would be a captive audience to these advertisements. Revenue derived from these advertisements may be used to offset network costs, thus allowing network providers to provide improved services to their customers at lower prices.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the claimed invention.

FIG. 1 illustrates an embodiment of a hybrid fiber twisted pair local loop architecture.

FIG. 2 is a block diagram of an embodiment of an intelligent services director consistent with the architecture shown in FIG. 1.

FIGS. 3A and 3B illustrate an embodiment of a video phone consistent with the architecture shown in FIG. 1.

FIG. 4A is a block diagram of an embodiment of a facilities management platform consistent with the architecture shown in FIG. 1.

FIG. 4B illustrates a block diagram of an embodiment of a network server platform consistent with the architecture shown in FIG. 1.

FIG. 5 illustrates an embodiment of a videophone display showing an advertisement.

FIG. 6 illustrates another embodiment of a videophone display showing an advertisement.

FIG. 7 illustrates an exemplary data structure that may be used to identify the type of telephone being used in a telephone link.

FIG. 8 is a flow chart showing exemplary steps for implementing advertising methods according to the present invention.

### DETAILED DESCRIPTION OF PREFERRED EMBODIMENTS

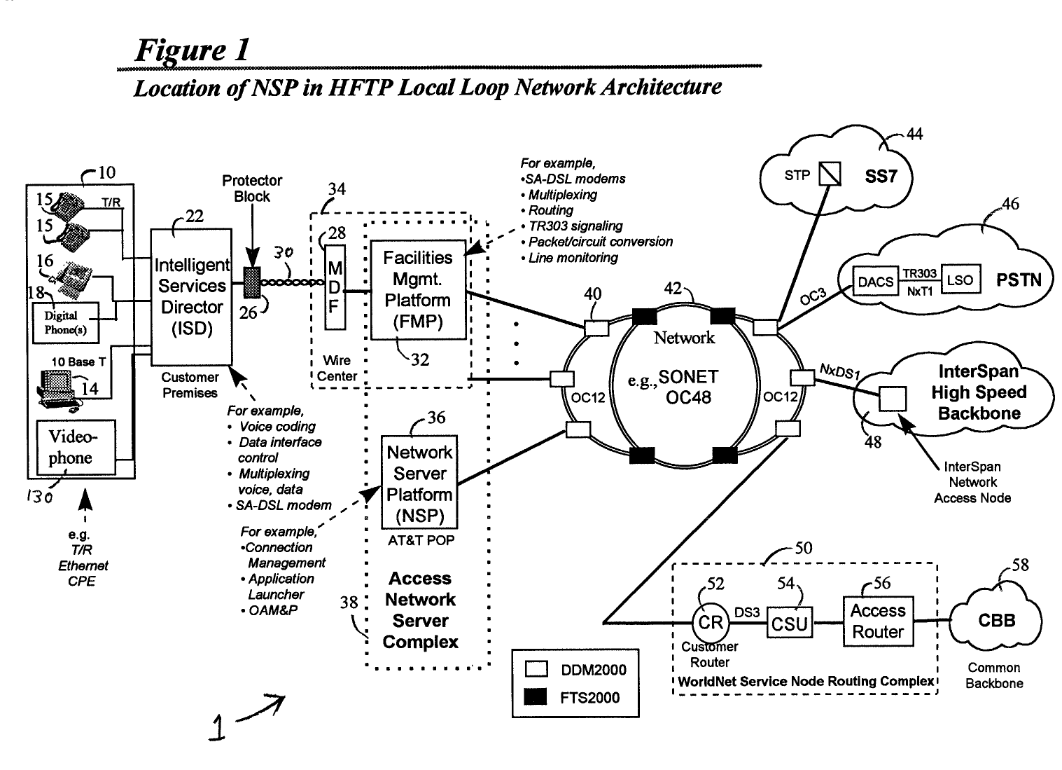

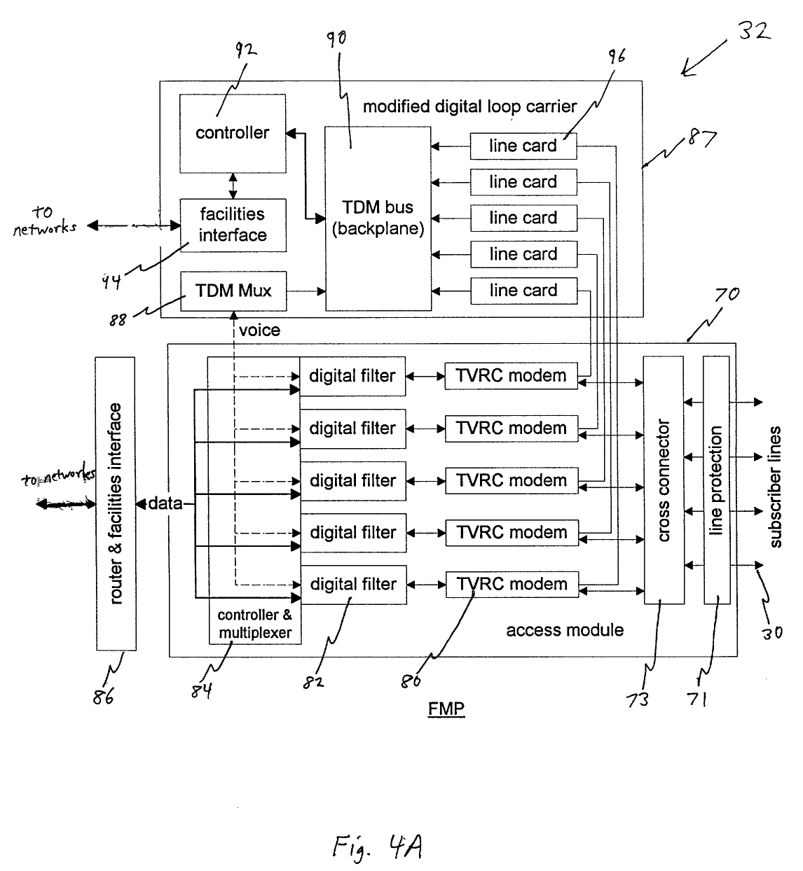

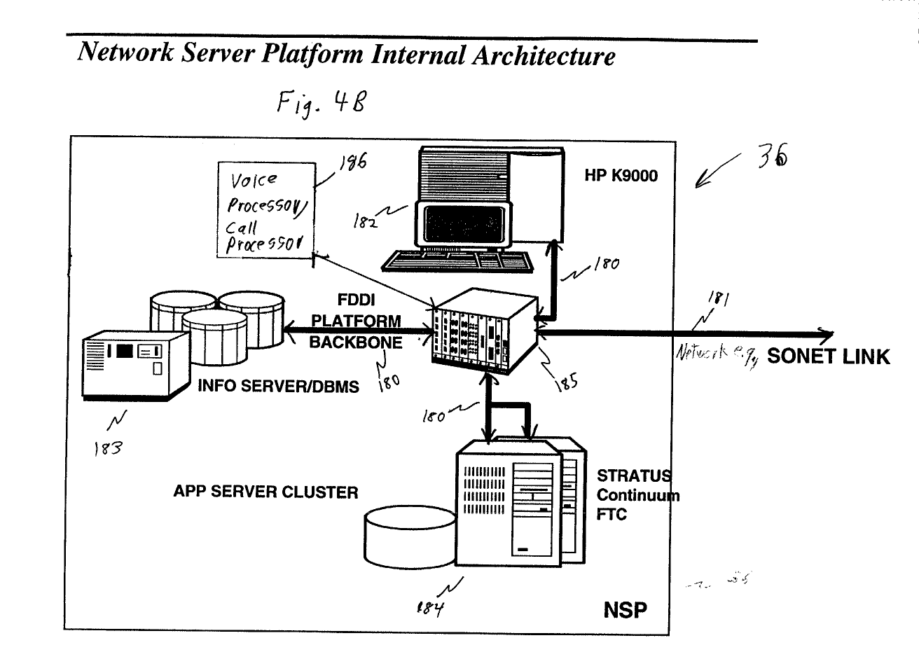

Referring to FIG. 1, a first exemplary communication network architecture employing a hybrid fiber, twisted-pair (HFTP) local loop 1 architecture is shown. An intelligent services director (ISD) 22 may be coupled to a central office 34 via a twisted-pair wire, hybrid fiber interconnection, wireless and/or other customer connection 30, a connector block 26, and/or a main distribution frame (MDF) 28. The ISD 22 and the central or local office 34 may communicate with each other using, for example, framed, time division, frequency-division, synchronous, asynchronous and/or spread spectrum formats, but in exemplary embodiments uses DSL modem technology. The central office 34 preferably includes a facilities management platform (FMP) 32 for processing data exchanged across the customer connection 30. The FMP 32 may be configured to separate the plain old telephone service (POTS) from the remainder of the data on the customer connection 30 using, for example, a tethered virtual radio channel (TVRC) modem (shown in FIG. 4A). The remaining data may be output to a high speed backbone network (e.g., a fiber-optic network) such as an asynchronous transfer mode (ATM) switching network. The analog POTS data may be output directly to a public switch telephone network (PSTN) 46, and/or it may be digitized, routed through the high speed backbone network, and then output to the PSTN 46.

The FMP 32 may process data and/or analog/digitized voice between customer premise equipment (CPE) 10 and any number of networks. For example, the FMP 32 may be interconnected with a synchronous optical network (SONET) 42 for interconnection to any number of additional networks such as an InterSpan backbone 48, the PSTN 46, a public switch switching network (e.g. call setup SS7-type network 44), and/or a network server platform (NSP) 36. Alternatively, the FMP 32 may be directly connected to any of these networks. One or more FMPs 32 may be connected directly to the high speed backbone network (e.g., direct fiber connection with the SONET network 42) or they may be linked via a trunk line (e.g., trunks 40 or 42) to one or more additional networks.

The NSP 36 may provide a massive cache storage for various information that may be provided across the SONET net 42 to the FMP 32 and out to the ISD 22. The NSP 36 and the FMP 32 may collectively define an access network server complex 38. The NSP 36 may be interconnected with multiple FMPs 32. Furthermore, each FMP 32 may interconnect with one or more ISDs 22. The NSP 36 may be located anywhere but is preferably located in a point-of-presence (POP) facility. The NSP 36 may further act as a gateway to, for example, any number of additional services.

The ISD 22 may be interconnected to various devices such as a videophone 130, other digital phones 18, set-top devices, computers, and/or other devices comprising the customer premise equipment 10. The customer premise equipment may individually or collectively serve as a local network computer at the customer site. Application applets may be downloaded from the NSP 36 into some or all of the individual devices within the customer premise equipment 10. Where applets are provided by the NSP 36, the programming of the applets may be updated such that the applets are continually configured to the latest software version by the interexchange carrier. In this way, the CPE 10 may be kept up to date by simply re-loading updated applets. In addition, certain applets may be resident on any of the CPE 10. These resident applets may be periodically reinitialized by simply sending a request from, for example, a digital phone 18 and/or a videophone 130 to the FMP 32 and thereafter to the NSP 36 for reinitialization and downloading of new applets. To ensure widespread availability of the new features made possible by the present architecture, the customer premise equipment may be provided to end users either at a subsidized cost or given away for free, with the cost of the equipment being amortized over the services sold to the user through the equipment.

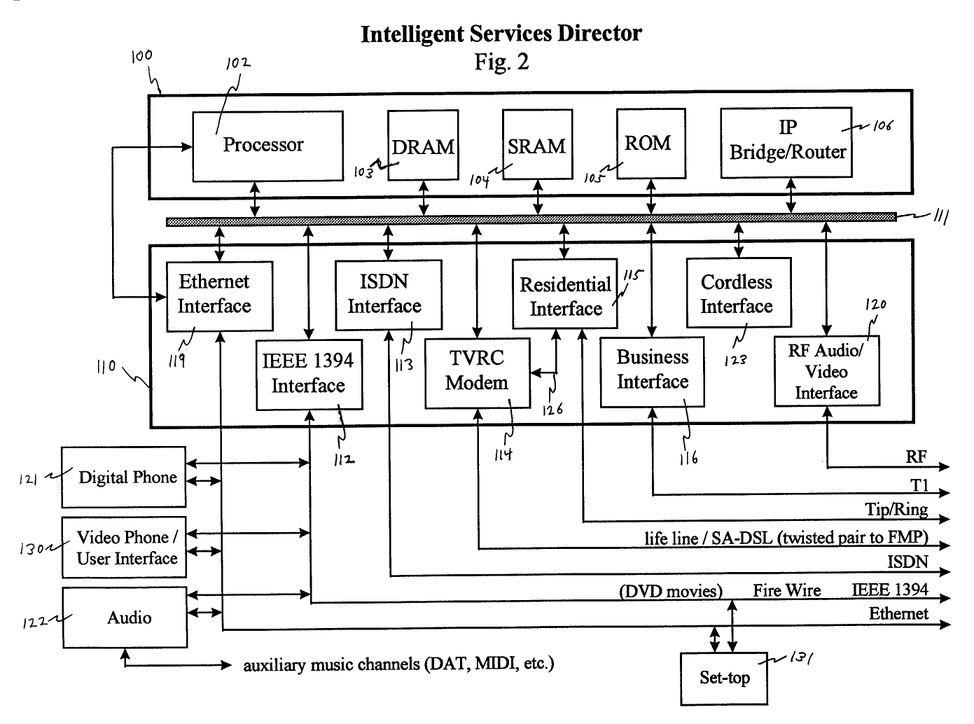

Referring to FIG. 2, the ISD 22 may connect with a variety of devices including analog and digital voice telephones 15, 18; digital videophones 130, devices for monitoring home security, meter reading devices (not shown), utilities devices/energy management facilities (not shown), facsimile devices 16, personal computers 14, and/or other digital or analog devices. Some or all of these devices may be connected with the ISD 22 via any suitable mechanism such as a single and/or multiple twisted-pair wires and/or a wireless connection. For example, a number of digital devices may be multi-dropped on a single twisted-pair connection. Similarly, analog phones and other analog devices may be multi-dropped using conventional techniques.

The ISD 22 may be located within the home/business or mounted exterior to the home/business. The ISD 22 may operate from electrical power supplied by the local or central office 34 and/or from the customer's power supplied by the customer's power company. Where the ISD 22 includes a modem, it may be desirable to power the ISD 22 with supplemental power from the home in order to provide sufficient power to enable the optimal operation of the modem.

As shown in FIG. 2, in some embodiments the ISD 22 may include a controller 100 which may have any of a variety of elements such as a central processing unit 102, a DRAM 103, an SRAM 104, a ROM 105 and/or an internet protocol (IP) bridge router 106 connecting the controller 100 to a system bus 111. The system bus 111 may be connected with a variety of network interface devices 110. The network interface devices 110 may be variously configured to include an integrated services digital network (ISDN) interface 113, an Ethernet interface 119 (e.g., for 28.8 kbs data, 56 kbs data, or ISDN), an IEEE 1394 “fire wire” interface 112 (e.g., for a digital videodisc device (DVD)), a TVRC modem interface 114 (e.g., for a digital subscriber line (DSL) modem), a residential interface 114, (e.g., standard POTS phone systems such as tip ring), a business interface 116 (e.g., a T1 line and/or PABX interface), a radio frequency (RF) audio/video interface 120 (e.g., a cable television connection), and a cordless phone interface 123 (e.g., a 900 MHZ transceiver). Connected to one of the network interfaces and/or the system bus 111 may be any number of devices such as an audio interface 122 (e.g., for digital audio, digital telephones, digital audio tape (DAT) recorders/players, music for restaurants, MIDI interface, DVD, etc.), a digital phone 121, a videophone/user interface 130, a television set-top device 131 and/or other devices. Where the network interface is utilized, it may be desirable to use, for example, the IEEE 1394 interface 112 and/or the Ethernet interface 119.

A lifeline 126 may be provided for continuous telephone service in the event of a power failure at the CPE 10. The lifeline 126 may be utilized to connect the ISD 22 to the local telecommunications company's central office 34 and, in particular, to the FMP 32 located in the central office 34.

The ISD may be variously configured to provide any number of suitable services. For example, the ISD 22 may offer high fidelity radio channels by allowing the user to select a particular channel and obtaining a digitized radio channel from a remote location and outputting the digital audio, for example, on audio interface 122, video phone 130, and/or digital phones 121. A digital telephone may be connected to the audio interface 122 such that a user may select any one of a number of digital audio service channels by simply having the user push a digital audio service channel button on the telephone and have the speaker phone output particular channels. The telephone may be preprogramed to provide the digital audio channels at a particular time, such as a wake up call for bedroom mounted telephone, or elsewhere in the house. The user may select any number of services on the video phone and/or other user interface such as a cable set-top device. These services may include any number of suitable services such as weather, headlines in the news, stock quotes, neighborhood community services information, ticket information, restaurant information, service directories (e.g., yellow pages), call conferencing, billing systems, mailing systems, coupons, advertisements, maps, classes, Internet, pay-per-view PPV), and/or other services using any suitable user interface such as the audio interface 122, the video phone/user interface 130, digital phones, 121 and/or another suitable device such as a settop device 131.

In further embodiments, the ISD 22 may be configured as an IP proxy server such that each of the devices connected to the server utilizes transmission control protocol/internet protocol (TCP/IP) protocol. This configuration allows any device associated with the ISD to access the Internet via an IP connection through the FMP 32. Where the ISD 22 is configured as an IP proxy server, it may accommodate additional devices that do not support the TCP/IP protocol. In this embodiment, the ISD 22 may have a proprietary or conventional interface connecting the ISD 22 to any associated device such as to the set top box 131, the personal computer 14, the video telephone 130, the digital telephone 18, and/or some other end user device.

In still further embodiments, the ISD 22 may be compatible with multicast broadcast services where multicast information is broadcast by a central location and/or other server on one of the networks connected to the FMP 32, e.g., an ATM-switched network. The ISD 22 may download the multicast information via the FMP 32 to any of the devices connected to the ISD 22. The ISD 22 and/or CPE 10 devices may selectively filter the information in accordance with a specific customer user's preferences. For example, one user may select all country music broadcasts on a particular day while another user may select financial information. The ISD 22 and/or any of the CPE 10 devices may also be programmed to store information representing users' preferences and/or the received uni-cast or multicast information in memory or other storage media for later replay. Thus, for example, video clips or movies may be multicast to all customers in the community with certain users being preconfigured to select the desired video clip/movie in real time for immediate viewing and/or into storage for later viewing.

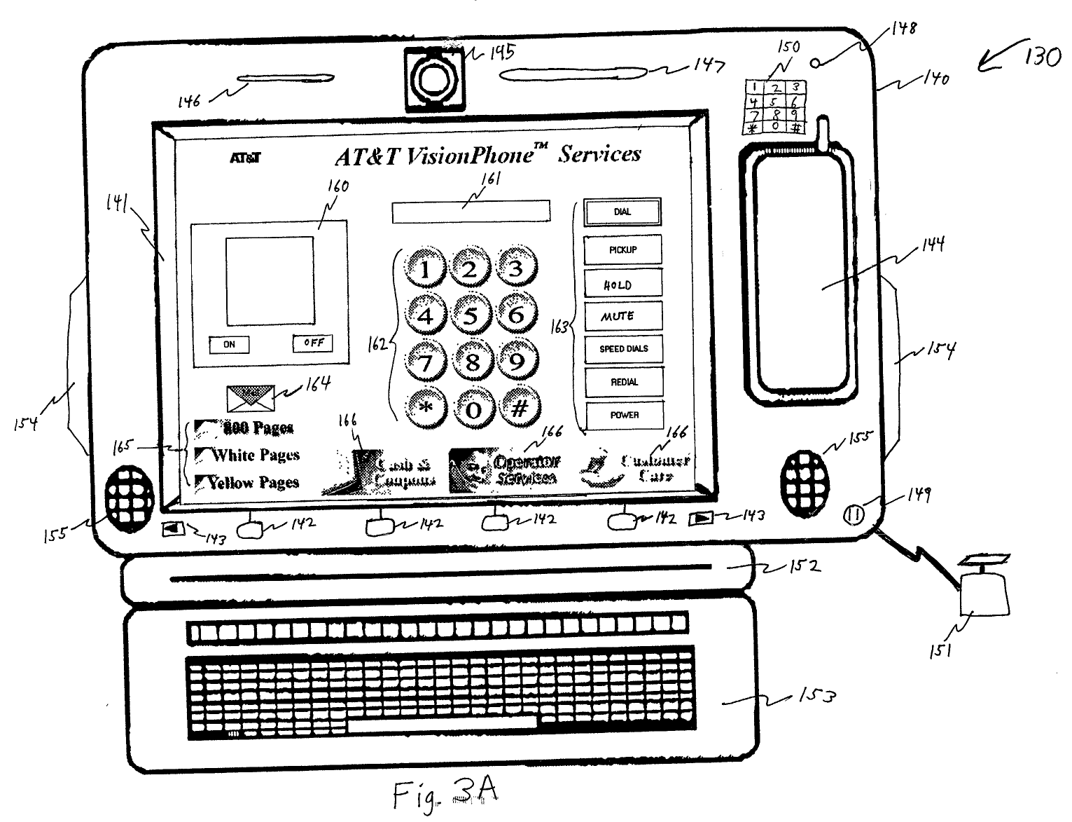

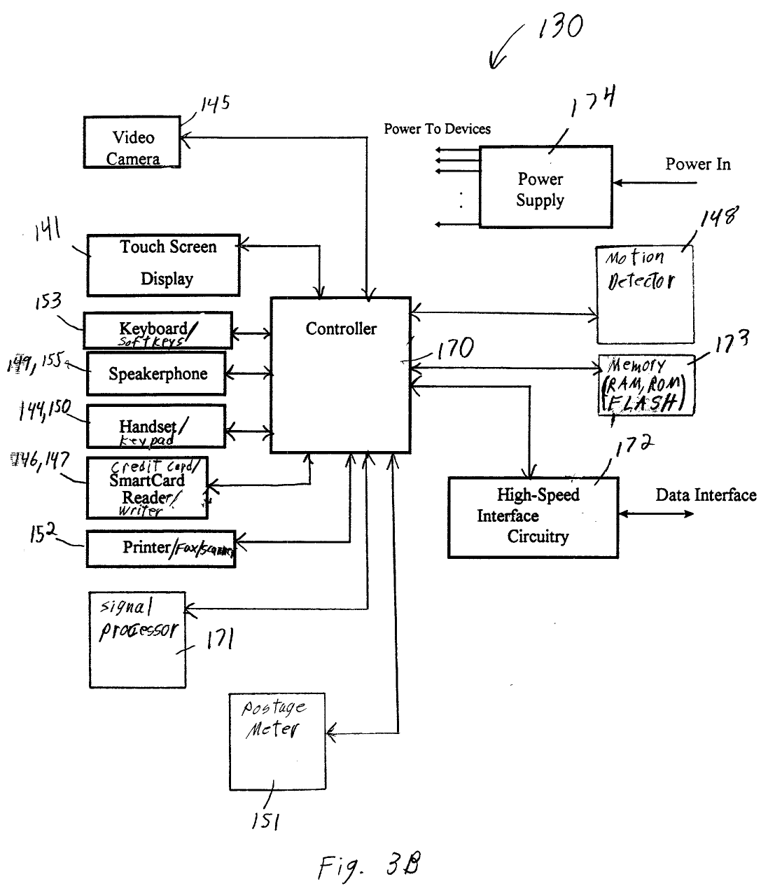

Referring to FIG. 3A, a videophone 130 may include a touch screen display 141 and soft keys 142 around the perimeter of the display 141. The display may be responsive to touch, pressure, and/or light input. Some or all of the soft keys 142 may be programmable and may vary in function depending upon, for example, the applet being run by the videophone 130. The function of each soft key may be displayed next to the key on the display 141. The functions of the soft keys 142 may also be manually changed by the user by pressing scroll buttons 143. The videophone 140 may also include a handset 144 (which may be connected via a cord or wireless connection to the rest of the videophone and/or directly to the ISD), a keypad 150, a video camera 145, a credit card reader 146, a smart card slot 147, a microphone 149, a motion and/or light detector 148, built-in speaker(s) 155, a printer/scanner/facsimile 152, and/or external speakers 154 (e.g., stereo speakers). A keyboard 153 and/or a postage scale 151 may also be connected to the videophone 130. Any or all of the above-mentioned items may be integrated with the videophone unit itself or may be physically separate from the videophone unit. A block diagram of the video phone unit is shown in FIG. 3B. Referring to FIG. 3B, in addition to the items above, the video phone 130 may also include a signal processor 171, high speed interface circuitry 172, memory 173, power supply 174, all interconnected via a controller 170.

When the videophone 130 is used as a video telephone, the display 141 may include one or more video window(s) 160 for viewing a person to whom a user is speaking and/or showing the picture seen by the person on the other end of the video phone. The display may also include a dialed-telephone-number window 161 for displaying the phone number dialed, a virtual keypad 162, virtual buttons 163 for performing various telephone functions, service directory icons 165, a mail icon 164, and/or various other service icons 166 which may be used, for example, for obtaining coupons or connecting with an operator. Any or all of these items may be displayed as virtual buttons and/or graphic icons and may be arranged in any combination. Additionally, any number of other display features may be shown on the video phone in accordance with one or more of the applications incorporated by reference below.

Referring to FIG. 4A, the FMP 32 may coordinate the flow of data packets, separate voice signals from other signals, perform line monitoring and switching functions, and/or convert between analog and digital signals. The FMP 32 may process data sent from the CPE 10 to the central or local office 34 by separating and reconstructing analog voice signals, data, and control frames. The FMP 32 may process data sent from the central or local office 34 to the CPE 10 by separating control messages from user information, and configure this information into segments that for transport across the digital subscriber loop. The FMP 32 may also terminate the link layer associated with the digital subscriber loop.

In some embodiments, the FMP 32 may include an access module 70 and a digital loop carrier 87. The access module 70 may include a line protector 71, a cross-connector 73, a plurality of TVRC modems 80, a plurality of digital filters 82, a controller multiplexer 84, and/or a router and facilities interface 86. The digital loop carrier 87 may include a plurality of line cards 96, a time domain multiplexing (TDM) multiplexor (MUX) 88, a TDM bus 90, a controller 92, and/or a facilities interface 94.

During normal operations, digital signals on the customer connection 30 (e.g., twisted-pair lines) containing both voice and data may be received by the TVRC modems 80 via the line protector 71 and the cross-connector 73. Preferably, the line protector 71 includes lightning blocks for grounding power surges due to lightning or other stray voltage surges. The TVRC modems 80 may send the digital voice and/or data signals to the controller multiplexor 84 and the digital filters 82. The digital filters 82 may separate the voice signals from the digital data signals, and the controller multiplexor 84 may then multiplex the voice signals and/or data signals received from the digital filters 82. The controller multiplexor 84 may then send multiplexed voice signals to the TDM MUX 88 and the data signals to the router and facilities interface 86 for transmission to one or more external networks. The TDM MUX 88 may multiplex the voice signals from the controller multiplexor 84 and/or send the voice signals to the TDM bus 90, which may then send the digital voice signals to the controller 92 and then to the facilities interface 94 for transmission to one or more external networks. Both the router and facilities interface 86 and the facilities interface 94 may convert between electrical signals and optical signals when a fiber optic link is utilized.

When there is a failure of the digital data link (e.g., if there is a failure of the TVRC modems 80 at the FMP 32 or the TVRC modem 114 at the ISD 22), only analog voice signals might be sent over the subscriber lines 30. In such a case, the analog voice signals may be directly routed to the line cards 96, bypassing the TVRC modems 80, the digital filters 82, the controller multiplexor 84, and the TDM MUX 88. Thus, voice communication is ensured despite a failure of the digital data link. The line cards 96 may convert the analog voice signals into digital format (e.g., TDM format) and send the digitized voice data onto the TDM bus 90 and eventually through the controller 92 and the facilities interface 94 for transmission to one or more external networks.

Referring to FIG. 4B, the NSP 36 may be variously configured to provide any number of services provided by a server such as information services, Internet services, pay-per-view movie services, data-base services, commercial services, and/or other suitable services. In the embodiment shown in FIG. 4B, the NSP 36 includes a router 185 having a backbone 180 (e.g., a fiber distributed data interface (FDDI) backbone) that interconnects a management server 182, an information/database server 183, and/or one or more application server clusters 184. The NSP 36 may be connected via the router 185 by a link 181 to one or more external networks, NSPs 36, and/or an FMPs 32. The information/data base server 183 may perform storage and/or database functions. The application server cluster 184 may maintain and control the downloading of applets to the ISD 22. The NSP 36 may also include a voice/call processor 186 configured to handle call and data routing functions, set-up functions, distributed operating system functions, voice recognition functions for spoken commands input from any of the ISD connected devices as well as other functions.

Videophones may communicate/link with other videophones, other video enabled devices, and/or non video-enabled devices (e.g., a conventional telephone). A phone may be non-video enabled if it does not have the capability to send video data, receive video data, process video data, display video data, and/or generate video data. A phone that is capable of any of these may sometimes be video enabled and sometimes non-video enabled. For example, a user of a videophone may turn off the camera 145, in which case the videophone may be considered non-video enabled while the camera 145 is turned off. Where a videophone is linked with a non-video enabled device, some or all of the display of the videophone may be blank, in a screen-saver mode, or otherwise not put to any good use. To take advantage of the unused videophone display 141, advertisements may be displayed on it. Advertisements may be also be displayed when a videophone user is put on hold, communicating with a non-video enabled user, and/or receiving an a message from a multimedia anwering machine.

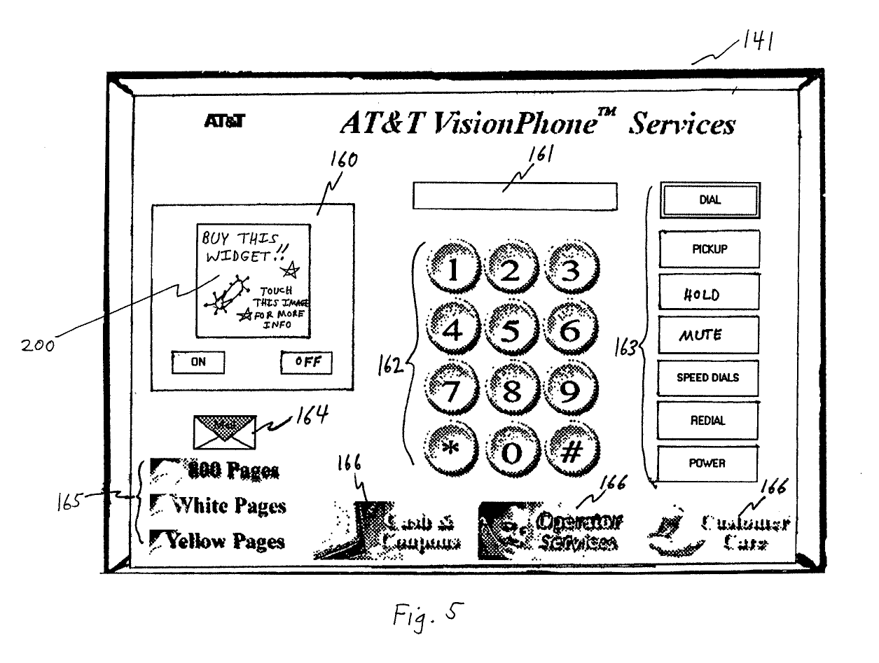

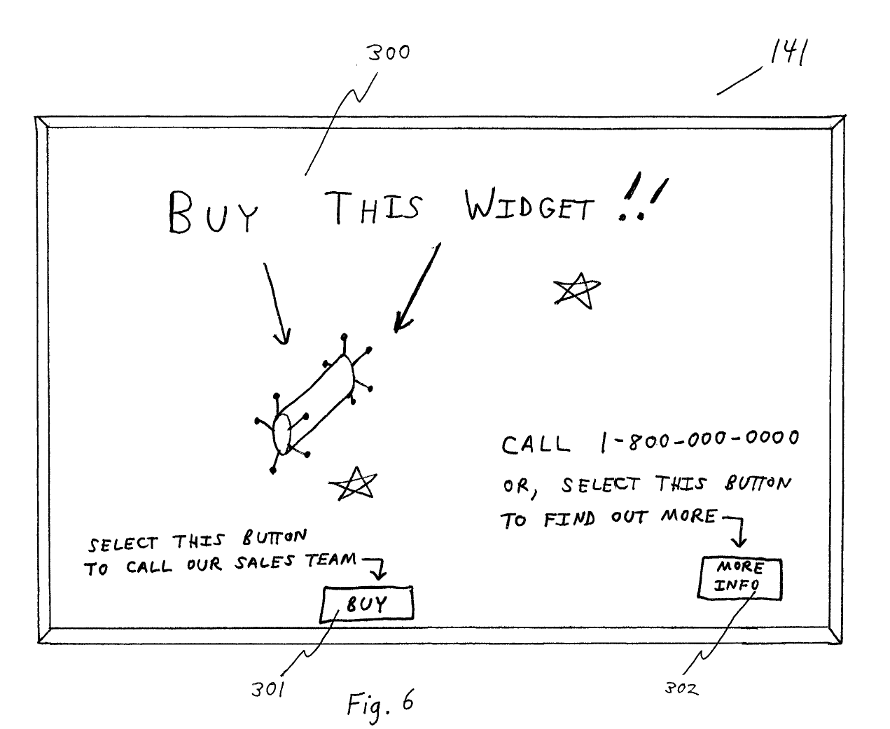

Referring to FIG. 5, one or more video advertisements 200 may be displayed on the display 141 of the videophone 130. Audio may also be mixed in with the video, especially when the user is put on hold. The advertisement 200 in FIG. 5 is shown to be located in the video window 160. However, one or more advertisements may be displayed anywhere on the display 141. An advertisement may move around the screen, fade in and out, blink on and off, spin, and/or change in size. An advertisement may also be sized to fit the entire display 141, as does an advertisement 300 shown in FIG. 6.

As shown in FIGS. 5 and 6, a videophone user may select a larger and/or more detailed version of an advertisement that interests the user by selecting the advertisement 200. Selecting an advertisement 200 may be accomplished by, for example, touching the advertisement 200 and/or speaking a command. In some embodiments, selecting the advertisement 200 may cause a larger and/or more detailed version of the advertisement 200 to appear, such as the advertisement 300 shown in FIG. 6. The user may further return to an original display as shown in FIG. 5 by, for instance, touching the advertisement 300 and/or selecting a function key 142.

An advertisement 200, 300 may include one or more graphic icons such as buttons 301, 302 and/or may be linked to one or more function keys 142. When selected, these buttons 301, 302, other icons, and/or function keys 142 may provide the user with additional information about the product being advertised, connect the user with a pre-defined telephone number (e.g., by disconnecting the current call or by multiple-party teleconferencing), connect the user to an Internet web page, and/or provide a user with additional related advertisements.

In some embodiments, an advertisement 200, 300 may be generated by the FMP 32, the NSP 36, and/or any other service provider or device connected directly or indirectly with the network 42. In further embodiments, an advertisement 200, 300 may be generated by the videophone 130, the CPE 10, and/or the ISD 22. In any of these embodiments, advertisements may be downloaded from the FMP 32, the NSP 36, and/or any other service provider or device on a periodic basis and/or during low-use times such as the middle of the night or when the videophone is not being used. Alternatively, advertisements may be received live on an as-needed basis from any of the above-mentioned devices. Advertisements may be sent through data channels and/or via protocols (e.g., IEEE 802.3 Ethernet) used for transporting audio, video, and/or data in any of the applications incorporated herein by reference.

In some embodiments, the FMP 32, the NSP 36, the ISD 22, the CPE 10, the videophone 130, and/or any other service provider or device connected directly or indirectly with the network 42 may keep track of a particular user's advertising interests. For example, if a customer regularly selects more information for hair care products, preference information regarding the customer's preferences may be stored. This preference information may be used to customize the types of products that are advertised to that customer. The type of advertisements displayed may also depend upon the types of parties (e.g., family, business, government, etc.) initiating and/or receiving a call, the time of day, the date, the day of the week, the weather, and/or the length of the telephone call. Thus, during snowy weather, more advertisements directed to, for example, snow tires or other snow-related products may be displayed. As another example, if one of the parties to a call is a business, more business-related advertisements (e.g., office supplies) may be displayed.

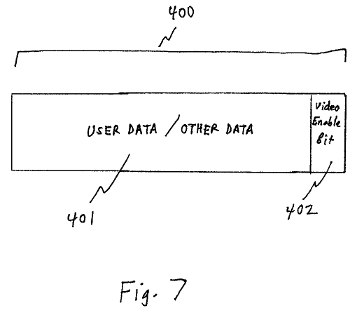

Referring to FIG. 7, data may be sent by one or more parties during the initiation of a telephone call and/or throughout a telephone call. As an exemplary embodiment, the data will be described as being in the form of data packets 400. However, this data may be digital or analog and may be in the form of data frames and/or packets (e.g., data packet 400), or it may be non-packetized. Furthermore, this data may be multiplexed with other types of data and/or signals, including analog voice data, digital voice data, and/or digital video data. If a data packet 400 is sent throughout the telephone call, the data packet 400 may be sent periodically. Alternatively, the data packet 400 may be sent only when a party changes video capabilities (e.g., if a party switches from a conventional phone to a videophone or if the party turns off the display of a videophone). The data packet 400 may include user and/or other data 401 identifying a particular type of device that the party sending the data 400 is using, protocol-related data, time stamp data, a synchronizing signal or sequence, voice data, video data, and/or any other user data.

The data packet 400 may further include, for example, a video enable bit 402 that may identify whether the party sending the data packet 400 is capable of sending and/or receiving video data. The data packet 400 may be generated by the videophone 130, the ISD 22, the CPE 10, the FMP 32, the NSP 36, and/or any other device connected to the network 42.

In operation, data packets 400 and/or video enable bits 402 may be received, intercepted, interpreted, and/or passed on by the FMP 32, the NSP 36, the ISD 22, the CPE 10, the videophone 130, and/or any other service provider and/or device connected indirectly and/or directly to the network 42. The device receiving and/or interpreting the data packet 400 may read the video enable bit 402 and/or other data such as user data packet 401 to determine whether the party sending the data packet 400 is capable of sending and/or receiving video data. For example, if the video enable bit 402 is enabled (e.g., set to one), this may mean that the party generating the video enable bit 402 is capable of sending and/or receiving video data (“video enabled”). On the other hand, if the video enable bit 402 is disabled (e.g., set to zero), this may mean that the party generating the video enable bit 402 is not capable of or chooses not to send and/or receive video data. Alternatively, a party using conventional telephone equipment may not have the capability to send the data packet 400 (“video disabled”). In such a case, the lack of a data packet 400 may be interpreted by the receiving party in a predefined way (e.g., no data packet 400 means non-video enabled). the video enable bit 402 and/or other data 401 may also be used to determine whether a party is on hold. For instance, if Party 2 places Party 1 on hold, then Party 2 may send a disabled video enable bit 402. Party 2 may then view advertisements in response to receiving a disabled video enable bit 402.

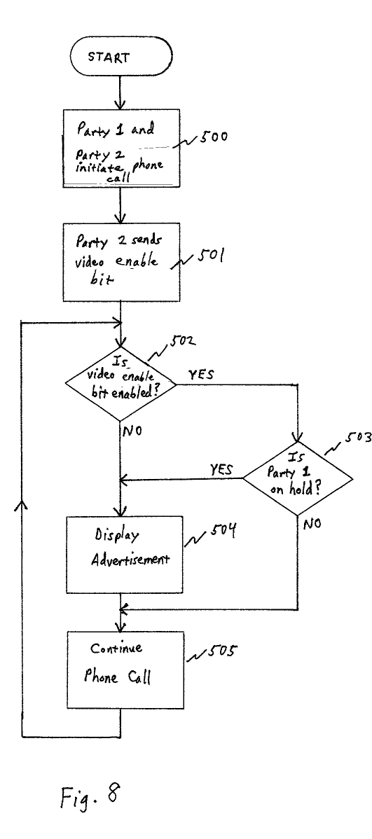

Referring to FIG. 8, a telephone call bay be initiated between at least a Party 1 and a Party 2 (step 500). Upon establishing a telephone link between Party 1 and Party 2, Party 1 and/or Party 2 may send the video enable bit 402 (step 501). If Party 2 has a conventional telephone, then no video enable bit 402 at all may be sent, and/or another device such as Party 2's ISD 22 may generate and send out the video enable bit 402. If no video enable bit 402 is sent and/or the video enable bit 402 is disabled (step 502), then an advertisement 200, 300 may be displayed (step 504) on the videophone 130 of Party 1. If the video enable bit 402 is enabled (step 502), and if Party 1 is not on hold (step 503), then Party 1 may not see an advertisement, but instead may see video sent from Party 2 as the telephone call continues (step 505). On the other hand, if the video enable bit 402 is enabled (step 502), but Party 1 is on hold (step 503), then Party 1 may see an advertisement 200, 300 (step 504) while Party 1 is on hold. Depending upon the status of the video enable bit 502 throughout the phone call and/or whether Party 1 becomes on hold or returns to a live communication, then advertisements may or may not be displayed accordingly.

The following applications, filed concurrently herewith, are hereby incorporated by reference:

1. A Hybrid Fiber Twisted-pair Local Loop Network Service Architecture (Gerszberg 41-3-13);

2. Dynamic Bandwidth Allocation for use in the Hybrid Fiber Twisted-pair Local Loop Network Service Architecture (Gerszberg 42-4-14);

3. The VideoPhone (Gerszberg 43-9-2);

4. VideoPhone Privacy Activator (Gerszberg 44-10-3);

5. VideoPhone Form Factor (Gerszberg 45-11-4);

6. VideoPhone Centrally Controlled User Interface With User Selectable Options (Gerszberg 46-12-5);

7. VideoPhone User Interface Having Multiple Menu Hierarchies (Gerszberg 47-13-6);

8. VideoPhone Blocker (Gerszberg 79-38-26);

9. VideoPhone Inter-com For Extension Phones (Gerszberg 48-14-7);

10. Advertising Screen Saver (53-17);

11. VideoPhone FlexiView Advertising (Gerszberg 49-15-8);

12. VideoPhone Multimedia Announcement Answering Machine (Gerszberg 73-32-20);

13. VideoPhone Multimedia Announcement Message Toolkit (Gerszberg 74-33-21);

14. VideoPhone Multimedia Video Message Reception (Gerszberg 75-34-22);

15. VideoPhone Multimedia Interactive Corporate Menu Answering Machine Announcement (Gerszberg 76-35-23);

16. VideoPhone Multimedia Interactive On-Hold Information Menus (Gerszberg 77-36-24);

17. VideoPhone Advertisement When Calling Video Non-enabled VideoPhone Users (Gerszberg 78-37-25);

18. Motion Detection Advertising (Gerszberg 54-18-10);

19. Interactive Commercials (Gerszberg 55-19);

20. VideoPhone Electronic Catalogue Service (Gerszberg 50-16-9);

21. A Facilities Management Platform For Hybrid Fiber Twisted-pair Local Loop Network, Service Architecture (Barzegar 18-56-17);

22. Multiple Service Access on Single Twisted-pair (Barzegar (16-51-15);

23. Life Line Support for Multiple Service Access on Single Twisted-pair (Barzegar 17-52-16);

24. A Network Server Platform (NSP) For a Hybrid Fiber Twisted-pair (HFTP) Local Loop Network Service Architecture (Gerszberg 57-4-2-2-4);

25. A Communication Server Apparatus For Interactive Commercial Service (Gerszberg 58-20-11);

26. NSP Multicast, PPV Server (Gerszberg 59-21-12);

27. NSP Internet, JAVA Server and VideoPhone Application Server (Gerszberg 60-5-3-22-18);

28. NSP WAN Interconnectivity Services for Corporate Telecommuters (Gerszberg 71-9-7-4-21-6);

29. NSP Telephone Directory White-Yellow Page Services (Gerszberg 61-6-4-23-19);

30. NSP Integrated Billing System For NSP services and Telephone services (Gerszberg 62-7-5-24-20);

31. Network Server Platform/Facility Management Platform Caching Server (Gerszberg 63-8-6-3-5);

32. An Integrated Services Director (ISD) For HFTP Local Loop Network Service Architecture (Gerszberg 72-36-22-12);

33. ISD and VideoPhone Customer Premise Network (Gerszberg 64-25-34-13-5);

34. ISD Wireless Network (Gerszberg 65-26-35-14-6);

35. ISD Controlled Set-Top Box (Gerszberg 66-27-15-7);

36. Integrated Remote Control and Phone (Gerszberg 67-28-16-8);

37. Integrated Remote Control and Phone User Interface (Gerszberg 68-29-17-9);

38. Integrated Remote Control and Phone Form Factor (Gerszberg 69-30-18-10);

39. VideoPhone Mail Machine (Attorney Docket No. 3493.73170);

40. Restaurant Ordering Via VideoPhone (Attorney Docket No. 3493.73171);

41. Ticket Ordering Via VideoPhone (Attorney Docket No. 3493.73712);

42. Multi-Channel Parallel/Serial Concatenated Convolutional Codes And Trellis Coded Modulation Encode/Decoder (Gelblum 4-3);

43. Spread Spectrum Bit Allocation Algorithm (Shively 19-2);

44. Digital Channelizer With Arbitrary Output Frequency (Helms 5-3);

45. Method And Apparatus For Allocating Data Via Discrete Multiple Tones (filed Dec. 22, 1997, Attorney Docket No. 3493.20096—Sankaranarayanan 1-1);

46. Method And Apparatus For Reducing Near-End Cross Talk In Discrete Multi-Tone Modulators/Demodulators (filed Dec. 22, 1997, Attorney Docket No. 3493.37219—Helms 4-32-18).

The present application is #17 on the above list.

In addition, the following two patent applications are hereby incorporated by reference:

1. U.S. patent application Ser. No. 08/943,312 filed Oct. 14, 1997 entitled Wideband Communication System for the Home, to Robert R. Miller, II and Jesse E. Russell, and

2. U.S. patent application Ser. No. 08/858,170, filed May 14, 1997, entitled Wide Band Transmission Through Wire, to Robert R. Miller, II, Jesse E. Russell and Richard R. Shively.

While exemplary systems and methods embodying the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments.

We claim:

1. A network coupled to first and second phones, the first phone having a display, said network configured to send a video advertisement to the first phone when the second phone is not video enabled.

2. The network of claim 1 wherein the second phone is configured to send data to said network indicating whether the second phone is video enabled.

3. The network of claim 1 wherein the advertisement depends upon an identity of a first party using the first phone.

4. The network of claim 2 further configured to store product preferences of a first user associated with the first phone, wherein the advertisement further depends upon the product preferences.

5. A method comprising the step of displaying a video advertisement on a display of a first phone when a second phone is not video enabled.

6. The method of claim 5 including the steps of:
determining whether the second phone is video enabled; and
sending the advertisement to the first phone upon determining that the second phone is not video enabled.

7. The method of claim 6 wherein the step of determining includes the step of sending data from the second phone indicating whether the second phone is video enabled, and wherein the step of determining is based upon the data.

8. The method of claim 5 wherein the advertisement includes a graphic icon for presenting additional information to a user of the first phone responsive to the user selecting the icon.

9. The method of claim 5 wherein the advertisement includes a graphic icon for connecting a user of the first phone to a web page responsive to the user selecting the icon.

10. A phone for sending data indicating whether said phone is video enabled.

11. A method comprising the step of sending a video advertisement to a video enabled phone responsive to the phone being on hold.
